(19) United States
(12) Patent Application Publication
(10) Pub. No.: US 2023/0036817 A1
(43) Pub. Date: Feb. 2, 2023

(54) DETECTING DEVICE, TAMPER DETECTING SYSTEM, CENTRAL SERVER, PARTICIPANT SERVER, TAMPER DETECTING METHOD, AND PROGRAM

(71) Applicant: MITSUBISHI HEAVY INDUSTRIES, LTD., Tokyo (JP)

(72) Inventors: Reika USHIJIMA, Tokyo (JP); Satoru FUNAHASHI, Tokyo (JP); Fumikado ANZAI, Tokyo (JP); Kenji TAKAO, Tokyo (JP)

(21) Appl. No.: 17/781,237

(22) PCT Filed: Dec. 3, 2020
(86) PCT No.: PCT/JP2020/045045

§ 371 Date: May 31, 2022

(30) Foreign Application Priority Data
Dec. 6, 2019 (JP) 2019-221481

(51) Int. Cl. G06F 21/64; H04L 9/00

(52) U.S. Cl. CPC G06F 21/64; H04L 9/50

(57) ABSTRACT

A detecting device includes: a verification information acquiring unit (400) configured to acquire second verification information about block data recorded in a central server that generates and distributes block data configuring a block chain and first verification information about block data recorded in a plurality of participant servers that record the distributed block data in a ledger of each of the plurality of participant servers; and a comparison unit (401) configured to determine the presence or absence of tampering of the block data in the central server by comparing the first verification information with the second verification information.

### TECHNICAL FIELD

The present invention relates to a detecting device, a tamper detecting system, a central server. a participant server, a tamper detecting method, and a program. Priority is claimed on Japanese Patent Application No. 2019-221481, filed Dec. 6, 2019, the content of which is incorporated herein by reference.

### BACKGROUND ART

In recent years, as data management systems having high security, systems using a distributed ledger technology such as a block chain have become known (for example, see Patent Literature 1 and Patent Literature 2). As block chains. there are a public type in which a plurality of unspecified participants approve transactions and a permission type in which only some of participants having administrator authority approve transactions.

A permission-type block chain is composed of a plurality of participants (participant servers) authorized by a supervisor of a system and one central server selected from among these participant servers. When execution of a transaction is requested from a client, each of the plurality of participant servers performs verification and approval of details (transaction data) of the transaction. The central server generates block data including transaction data approved by participant servers of a predetermined number or more and distributes the generated block data to the participant servers. The block data that has been generated and distributed is added to and recorded in ledgers of the central server and the participant servers. In this way, in a permission-type block chain, transaction details are not disclosed to any server other than some of participant servers that have been authorized and the central server, and thus such a block chain is appropriate for handling information having high confidentiality.

### CITATION LIST

### Patent Literature

[Patent Literature 1]

Japanese Unexamined Patent Application First Publication No. 2017-207979
[Patent Literature 2]

PCT International Publication No. WO 2019/043466

### SUMMARY OF INVENTION

### Technical Problem

However, in a permission-type block chain, after approval is made by each participant server, re-verification of consistency of transaction data is not performed. In addition, there is a case that the participant servers do not perform verification and approval of block data distributed from the central server and record the block data in a ledger thereof, and thus it is possible that tampering of block data of the central server caused by an attack from the outside of the system or the like is not able to he detected.

In Patent Literature 2, a technology for securing the authenticity of data of owner nodes in a bitcoin network using a public-type block chain in which a wallet device of one transactor of the bitcoin network secures diversity of adjacent nodes by installing three owner nodes managed by the transactor within the bitcoin network and comparing data of each of the owner nodes with those of the others is disclosed. However, the technology of Patent Literature 2 is only for verification of authenticity of data of owner nodes but is not for verifying whether data has been tampered with in a miner generating block data or whether data has been tampered with in other nodes that are transit points of broadcast distribution. For this reason, even when such a technology is applied to a block chain, it is difficult to detect that a node generating block data has been tampered with.

The present invention is in view of such problems and provides a detecting device, a tamper detecting system, a central server, a participant server, a tamper detecting method, and a program capable of detecting tampering of block data in a central server that generates block data of a block chain.

### Solution to Problem

According to a first aspect of the present invention, there is provided a detecting device including: a verification information acquiring unit (400) configured to acquire second verification information about block data recorded in a central server (3) that generates and distributes block data configuring a block chain and first verification information about block data recorded in a plurality of participant servers (2) that record the distributed block data in a ledger of each of the plurality of participant servers; and a comparison unit (40) configured to determine the presence or absence of tampering of the block data in the central server (3) by comparing the first verification information with the second verification information.

According to a second aspect of the present invention, in the detecting device according to the first aspect, the verification information acquiring unit (400) acquires the block data recorded in each of the plurality of participant servers (2) and the central server (3) as the first verification information and the second verification information, respectively.

According to a third aspect of the present invention, in the detecting device according to the first aspect, the verification information acquiring unit (400) acquires a CRC value of the block data recorded in each of the plurality of participant servers (2) and the central server (3) as the first verification information and the second verification information, respectively.

According to a fourth aspect of the present invention, in the detecting device according to the first aspect, the verification information acquiring unit (400) acquires the number of pieces of the block data recorded in the plurality of participant servers (2) and the central server (3) as the first verification information and the second verification information, respectively.

According to a fifth aspect of the present invention, in the detecting device according to any one of the first to fourth aspects, the block chain includes a first block chain and a second block chain, the verification information acquiring unit (400) acquires the first verification information from each of the plurality of participant servers (2A, 2B) of the first block chain and the plurality of participant servers (2C, 2D) of the second block chain and acquires the second verification information from the central server (3A) of the first block chain and the central server (3B) of the second block chain, and the comparison unit (401) determines the presence or absence of tampering of the block data in the central server (3A, 3B) of the first block chain and the second block chain by comparing the second verification information acquired from the central server (3A) of the first block chain with the first verification information acquired from each of the plurality of participant servers (2C, 2D) of the second block chain and comparing the second verification information acquired from the central server (3B) of the second block chain with the first verification information acquired from each of the plurality of participant servers (2A, 2B) of the first block chain.

According to a sixth aspect of the present invention, the detecting device according to any one of the first to fifth aspects further includes a changing unit (403) configured to change one participant server (2) selected from among the plurality of participant servers (2) to the central server (3).

According to a seventh aspect of the present invention, there is provided a tamper detecting system including: a central server (3) configured to generate and distribute block data configuring a block chain; a plurality of participant servers (2) that record the distributed block data in a ledger of each of the plurality of participant servers; and a detecting device (2, 3). The participant server (2) includes: a transaction data verifying unit (201) configured to verify whether transaction data accepted from a client is valid; a recording processing unit (202) configured to record block data received from the central server (3) in a first recording medium (23); and a first verification information transmitting unit (203) configured to transmit first verification information about the block data recorded in the first recording medium (23) to the detecting device (2, 3). The central server (3) includes: a block data generating unit (301) configured to generate block data including the transaction data determined as being valid by the plurality of participant servers (2) and record the generated block data in a second recording medium (33); a block data transmitting unit (302) configured to transmit the generated block data to the plurality of participant servers (2); and a second verification information transmitting unit (303) configured to transmit second verification information about the block data recorded in the second recording medium (33) to the detecting device. The detecting device (2, 3) includes: a verification information acquiring unit (400) configured to acquire the first verification information from each of the plurality of participant servers (2) and acquire the second verification information from the central server (3): and a comparison unit (401) configured to determine the presence or absence of tampering of the block data in the central server (3) by comparing the first verification information with the second verification information.

According to an eighth aspect of the present invention, in the tamper detecting system according to the seventh aspect, the central server (3) is one participant server (2) selected from among the plurality of participant servers (2).

According to a ninth aspect of the present invention, in the tamper detecting system according to the seventh aspect, the detecting device (2, 3) further includes a changing unit (403) configured to change one participant server (2) selected from among the plurality of participant servers (2) to the central server (3).

According to a tenth aspect of the present invention, in the tamper detecting system according to any one of the seventh to ninth aspects. at least one server among the plurality of participant servers (2) and the central server (3) includes a detection unit (40) functioning as a detecting device.

According to an eleventh aspect of the present invention, there is provided a central server including: a block data generating unit (301) configured to generate block data including transaction data determined as being valid by a plurality of participant servers and record the generated block data in a second recording medium (33); a block data transmitting unit (302) configured to transmit the generated block data to the plurality of participant servers (2); and a second verification information transmitting unit (303) configured to transmit second verification information about the block data recorded in the second recording medium (33) to a detecting device (2, 3) having a function of determining the presence or absence of tampering of the block data recorded in the second recording medium (33).

According to a twelfth aspect of the present invention, in the central server according to the 11th aspect, the second verification information transmitting unit (303) transmits the second verification information to the detecting device (2, 3) at one timing among a timing at which the block data is generated, a timing at which the second verification information is requested from the detecting device (2, 3), or a timing at which the participant server (2) reboots.

According to a thirteenth aspect of the present invention, there is provided a central server including: a block data generating unit (301) configured to generate block data including transaction data determined as being valid by a plurality of participant servers and record the generated block data in a second recording medium (33); a block data transmitting unit (302) configured to transmit the generated block data to the plurality of participant servers (2); and a second verification information transmitting unit (303) configured to transmit second verification information about the block data generated before the block data to he transmitted and recorded in the second recording medium (33) to a detecting device (2, 3) having a function of determining the presence or absence of tampering of the block data recorded in the second recording medium (33) at a timing at which the generated block data is transmitted to the plurality of participant servers (2) by the block data transmitting unit (302).

According to a fourteenth aspect of the present invention, there is provided a participant server including: a transaction data verifying unit (201) configured to verify whether transaction data accepted from a client is valid; a recording processing unit (202) configured to receive block data including the transaction data determined as being valid from a central server (3) and record the received block data in a first recording medium (23); and a first verification information transmitting unit (203) configured to transmit first verification information about the block data recorded in the first recording medium (23) to a detecting device (2, 3) having a function of determining the presence or absence of tampering of the block data recorded in a central server (3) that generates and distributes the block data configuring a block chain.

According to a fifteenth aspect of the present invention, in the participant server according to the 14th aspect, the first verification information transmitting unit (203) transmits the first verification information to the detecting device (2, 3) at one timing among a timing at which the block data is received from the central server (3), a timing at which the first verification information is requested from the detecting device (2, 3), or a timing at which the participant server (2) reboots.

According to a sixteenth aspect of the present invention, there is provided a tamper detecting method using a central server (3) configured to generate and distribute block data configuring a block chain, a plurality of participant servers (2) that record the distributed block data in a ledger of each of the plurality of participant servers, and a detecting device (2, 3), the tamper detecting method including: a step of verifying whether transaction data accepted from a client is valid in the participant server (2); a step of generating block data including the transaction data determined as being valid by the plurality of participant servers and recording the generated block data in a second recording medium (33) in the central server (3); a step of transmitting the generated block data to the plurality of participant servers (2) in the central server (3); a step of receiving the block data from the central server (3) and recording the received block data in a first recording medium (23) in the participant server (2); a step of transmitting first verification information about the block data recorded in the first recording medium (23) of the participant server (2) to the detecting device (2, 3) in the participant server (2); a step of transmitting second verification information about the block data recorded in the second recording medium (33) of the central server (3) to the detecting device (2, 3) in the central server (3); a step of acquiring the first verification information from each of the plurality of participant servers (2) and acquiring the second verification information from the central server (3) in the detecting device (2, 3); and a step of determining the presence or absence of tampering of the block data in the central server (3) by comparing the first verification information with the second verification information in the detecting device (2, 3).

According to a seventeenth aspect of the present invention, there is provided a program causing a computer of a detecting device to function. the program causing the computer to execute: a step of acquiring second verification information about block data recorded in a central server (3) that generates and distributes block data configuring a block chain and first verification information about block data recorded in a plurality of participant servers (2) that record the distributed block data in a ledger of each of the plurality of participant servers; and a step of determining the presence or absence of tampering of the block data by comparing the first verification information with the second verification information.

According to a eighteenth aspect of the present invention, there is provided a program causing a computer of a central server to function, the program causing the computer to execute: a step of generating block data including transaction data determined as being valid by a plurality of participant servers (2) and recording the generated block data in a second recording medium (33); a step of transmitting the generated block data to the plurality of participant servers (2): and a step of transmitting second verification information about the block data recorded in the second recording medium (33) to a detecting device (2, 3) having a function of determining the presence or absence of tampering of the block data recorded in the second recording medium (33).

According to a nineteenth aspect of the present disclosure, there is provided a program causing a computer of a central server to function, the program causing the computer to execute: a step of generating block data including transaction data determined as being valid by a plurality of participant servers (2) and recording the generated block data in a second recording medium (33); a step of transmitting the generated block data to the plurality of participant servers (2); and a step of transmitting second verification information about the block data generated before the block data to be transmitted and recorded in the second recording medium (33) to a detecting device (2, 3) having a function of determining the presence or absence of tampering of the block data recorded in the second recording medium (33) at a timing at which the generated block data is transmitted to the plurality of participant servers (2).

### Advantageous Effects of Invention

According to a detecting device. a central server, a tamper detecting system, a tamper detecting method, and a program relating to the present invention, tampering of block data in a central server that generates block data of a block chain can be detected.

### BRIEF DESCRIPTION OF DRAWINGS

FIG. 1 is a diagram illustrating a general configuration of a tamper detecting system according to a first embodiment.

FIG. 2 is a diagram illustrating a functional configuration of a participant server according to the first embodiment.

FIG. 3 is a diagram illustrating a functional configuration of a central server according to the first embodiment.

FIG. 4 is a diagram illustrating a functional configuration of a detection unit of each of a participant server and a central server according to the first embodiment.

FIG. 5 is a diagram illustrating an example of a process of a tamper detecting system according to the first embodiment.

FIG. 6 is a diagram illustrating an example of block data according to the first embodiment.

FIG. 7 is a diagram illustrating a function of a comparison unit according to the first embodiment.

FIG. 8 is a diagram illustrating an example of a process of a tamper detecting system according to a modified example of the first embodiment.

FIG. 9 is a diagram illustrating an example of a process of a tamper detecting system according to a second embodiment.

FIG. 10 is a diagram illustrating a functional configuration of a detection unit of each of a participant server and a central server according to a third embodiment.

FIG. 11 is a diagram illustrating an example of a process of a tamper detecting system according to the third embodiment.

FIG. 12 is a diagram illustrating a general configuration of a tamper detecting system according to a fourth embodiment.

FIG. 13 is a diagram illustrating an example of a process of the tamper detecting system according to the fourth embodiment.

FIG. 14 is a diagram illustrating an example of a hardware configuration of a participant server and a central server according to at least one embodiment.

### DESCRIPTION OF EMBODIMENTS

### First Embodiment

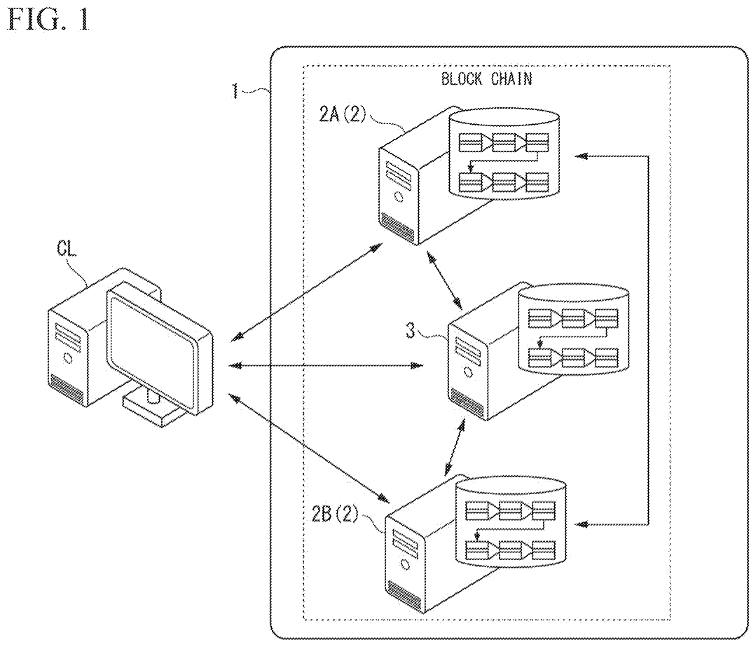

Hereinafter, a tamper detecting system 1 according to a first embodiment of the present invention will be described with reference to FIGS. 1 to 7. Hereinafter, an example in which the tamper detecting system 1 according to the present disclosure uses a permission-type block chain system, but the tamper detecting system is not limited thereto.

### (General Configuration)

FIG. 1 is a diagram illustrating a general configuration of the tamper detecting system according to the first embodiment.

As illustrated in FIG. 1, the tamper detecting system 1 includes a plurality of participant servers 2 (2A and 2B) and a central server 3.

In this embodiment, a block chain is composed of a plurality of participant servers 2 authorised by a system manager and one central server 3 selected from among the plurality of participant servers 2.

The participant server 2 verities and approves details of a transaction (transaction data) requested from a client CL. The client CL is a computer such as a personal computer, a smartphone, a tablet, or the like operated by a user conducting a transaction. In FIG. 1, although an example configuration in which the tamper detecting system 1 includes two participant servers 2A and 2B is illustrated, the configuration is not limited thereto. In another embodiment, the tamper detecting system 1 may include three or more participant servers 2.

The central server 3 generates block data including transaction data approved by participant servers 2 of a predetermined number or more and distributes the generated block data to plurality of participant servers 2. The block data that has been generated and distributed is recorded in the central server 3 and the plurality of participant servers 2.

In this embodiment. the plurality of participant servers 2 and the central server 3 function as detecting, devices detecting tampering of block data recorded in the central server 3.

(Functional Configuration of Participant Server)

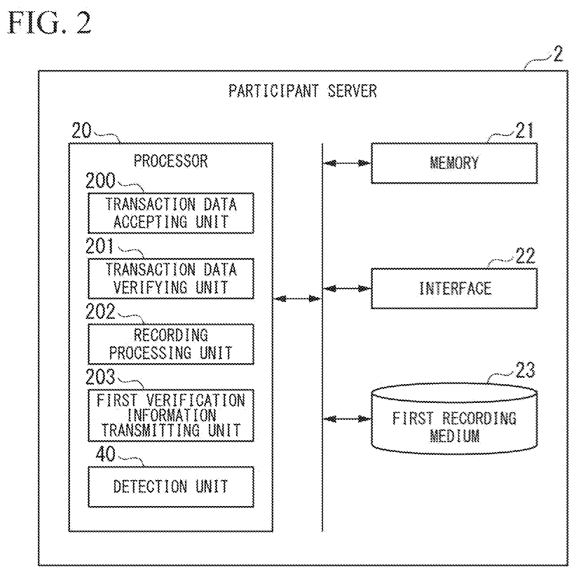

FIG. 2 is a diagram illustrating a functional configuration of the participant server according to the first embodiment.

As illustrated in FIG. 2, the participant server 2 is a computer that includes a processor 20. a memory 21, an interface 22, and a first recording medium 23. The participant servers 2A and 2B have the same functional configuration.

The processor 20 exhibits functions of a transaction data accepting unit 200, a transaction data verifying unit 201, a recording processing unit 202, a first verification information transmitting unit 203, and a detection unit 40 by operating in accordance with a program prepared in advance.

The transaction data accepting unit 200 accepts transaction data (a transaction execution request) from the client CL.

The transaction data verifying unit 201 verifies whether transaction data accepted from the client CL is valid.

The recording processing unit 202 receives block data including transaction data determined as being valid from the central server 3 and records the block data in a ledger of the first recording medium 23.

The first verification information transmitting unit 203 transmits first verification information about block data recorded in a ledger of the first recording medium 23 to the other participant servers 2 and the central server 3.

The detection unit 40 detects tampering of block data in the central server 3. A specific functional configuration of the detection unit 40 will be described below.

The memory 21 is a so-called main storage device such as a DRAM or the like and is a storage area required for the processor 20 to operate in accordance with a program.

The interface 22 is a communication interface for transmitting/receiving various kinds of information to/from the client CL, the central server 3, and the other participant servers 2 through a communication network.

The first recording medium 23 is a so-called auxiliary storage device such as an HDD, an SSD, or the like. In the first recording medium 23, transaction data, block data, and the like are recorded.

### (Functional Configuration of Central Server)

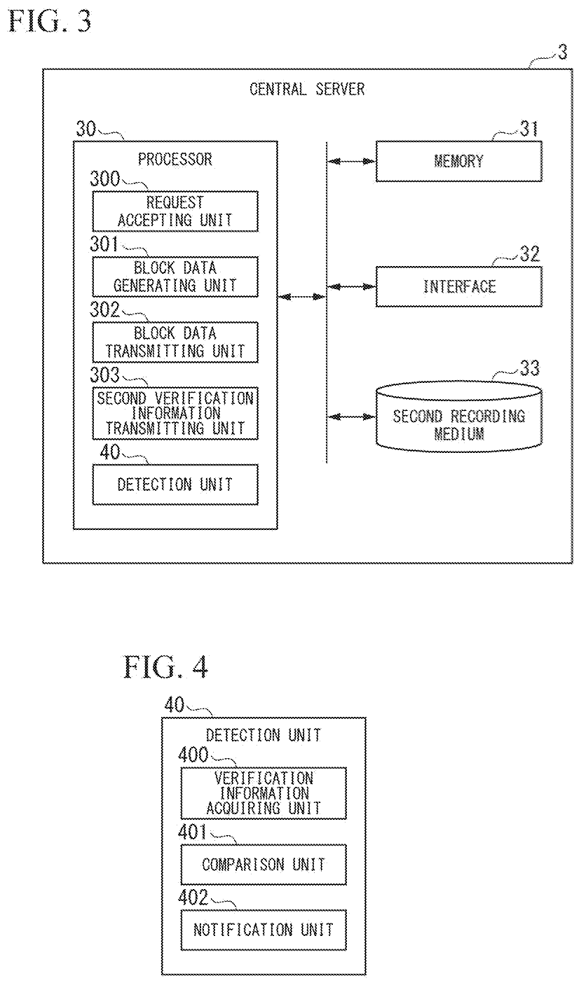

FIG. 3 is a diagram illustrating a functional configuration of the central server according to the first embodiment.

As illustrated in FIG. 3, the central server 3 is a computer that includes a processor 30, a memory 31, an interface 32, and a second recording medium 33.

The processor 30 exhibits functions of a request accepting unit 300, a block data generating unit 301, a block data transmitting unit 302, a second verification information transmitting unit 303, and a detection unit 40, by operating in accordance with a program prepared in advance.

The request accepting unit 300 accepts a request for generating block data including transaction data determined as being valid by a plurality of participant servers 2 from the client CL.

The block data generating unit 301 generates block data including transaction data determined as being valid by a plurality of participant servers 2 and records the generated block data in a ledger of the second recording medium 33.

The block data transmitting unit 302 transmits the generated block data to a plurality of participant servers 2.

The second verification information transmitting unit 303 transmits second verification information about block data recorded in the ledger of the second recording medium 33 to the participant server 2.

The detection unit 40 detects tampering of block data in the central server 3. The detection unit 40 of the central server 3 according to this embodiment has the same functional configuration as the detection unit 40 of the participant server 2. A specific functional configuration of the detection unit 40 will be described below.

The memory 31 is a so-called main storage device such as a DRAM or the like and is a storage area required for the processor 30 to operate in accordance with a program.

The interface 32 is a communication interface for transmitting/receiving various kinds of information to/from the client CL and the participant server 2 through a communication network.

The second recording medium 33 is a so-called auxiliary storage device such as an HDD, an SSD, or the like. In the second recording medium 33, block data and the like are recorded.

### (Functional Configuration of Detection Unit of Each of Participant Server and Central Server)

FIG. 4 is a diagram illustrating a functional configuration of the detection unit of each of a participant server and a central server according to the first embodiment.

As illustrated in FIG. 4. the detection unit 40 includes a verification information acquiring unit 400, a comparison unit 401, and a notification unit 402.

The verification information acquiring unit 400 acquires first verification information about block data recorded in each participant server 2 and second verification information about block data recorded in the central server 3 from a plurality of participant servers 2 and the central server 3, respectively. More specifically, in a participant server 2, the verification information acquiring unit 400 acquires first verification information from the other participant servers 2 and acquires second verification information from the central server 3. In addition, in the central server 3, the verification information acquiring unit 400 acquires first verification information from each of the plurality of participant servers 2.

The comparison unit 401 compares the first verification information with the second verification information and determines the presence or absence of tampering of block data in the central server.

The notification unit 402 notifies the participant servers 2 and the central server 3 (the other servers) of a result of comparison acquired by the comparison unit 401.

In addition, in this embodiment, an example in which each of the plurality of participant servers 2 and the central server 3 functions as a detecting device will be described. For this reason, each of the plurality of participant servers 2 and the central server 3 includes the detection unit 40, and the servers perform processes of detecting tampering of block data in parallel with each other. In another embodiment, at least one of the plurality of participant servers 2 and the central server 3 may function as a detecting device. For example, in a case in which only the participant server 2A functions as a detecting device, only the participant server 2A includes the detection unit 40, and the other participant server 2B and the central server 3 may omit the detection unit 40.

### (Process Flow)

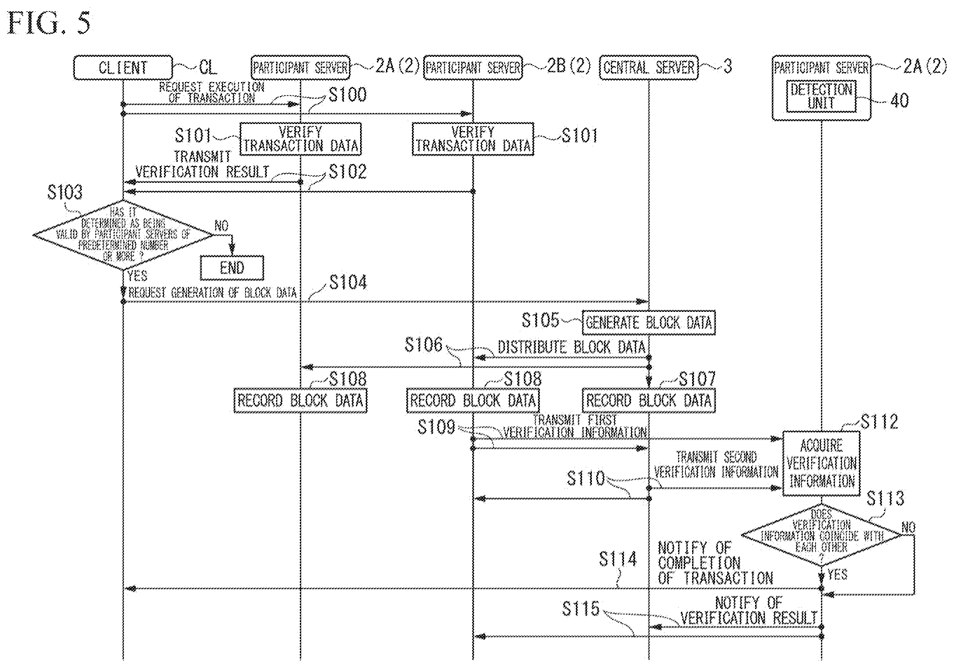

FIG. 5 is a diagram illustrating an example of a process of the tamper detecting system according to the first embodiment.

Hereinafter. an example of the process of the tamper detecting system 1 according to this embodiment will be described in detail with reference to FIG. 5. In this embodiment, each of the plurality of participant servers 2 and the central server 3 configuring the tamper detecting system 1 functions as a detecting device that detects tampering of block data. In FIG. 5, among the plurality of participant servers and the central server 3, a function of a detecting device (the function of the detection unit 40) in the participant server 2A is representatively described.

As illustrated in FIG. 5, the client CL requests each of the plurality of participant servers 2A and 2B to execute a transaction by transmitting transaction data representing transaction details (Step S100). In the transaction data, information representing transaction details is included. For example, in a case in which remittance is made, the information representing transaction details is information used for identifying a remitter and a remittee, an amount of remittance, and the like.

When the transaction data accepting unit 200 of each of the participant servers 2A and 2B receives transaction data from the client CL, the transaction data verifying unit 201 verifies whether or not the received transaction data is valid (whether or not transaction details are correct) (Step S101). For example, in a case in which remittance is to be made, the transaction data verifying unit 201 verifies, for example, consistency between the balance of a remitter of transaction data that has been newly received and an amount of the remittance by referring to transaction data included in past block data recorded on the first recording medium 23. In addition, the transaction data verifying unit 201 may verily whether or not a signature attached to the transaction data is correct.

Furthermore, the transaction data verifying unit 201 notifies a verification result indicating whether or not the transaction data is valid to the client CL (Step S102).

In a case in which transaction data has not been determined as being valid by participant servers 2 of a predetermined number or more among the plurality of participant servers 2 (Step S103: No), the client CL ends the process. On the other hand, in a case in which transaction data has been determined as being valid by participant servers 2 of the predetermined number or more (Step S103: Yes), the client CL transmits a generation request for generating block data including this transaction data to the central server 3 (Step S104).

When a generation request for generating block data is accepted by the request accepting unit 300 of the central server 3 from the client CL, the block data generating unit 301 generates block data including transaction data received from the client CL (Step S105). At this time, the block data generating unit 301 may re-verify the transaction data received from the client CL and generate block data only in a case in which the transaction data is valid.

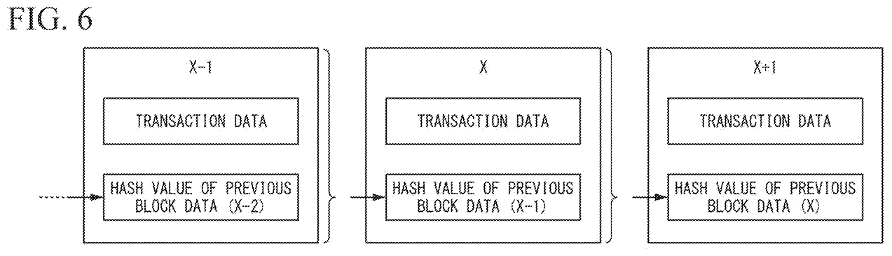

FIG. 6 is a diagram illustrating an example of block data according to the first embodiment.

As illustrated in FIG. 6, for example, the block data generating unit 301 generates block data X+1 including transaction data received together with a generation request from the client CL and a hash value of previous block data X.

In this embodiment, the hash value included in the block data X+1, for example, is assumed to be calculated by the block data generating unit 301 and recorded on the second recording medium 33 when the previous block data X is generated. In this case, the block data generating unit 301 generates the hash value included in the block data X+1 by writing a hash value of the block data X read from the second recording medium 33 into the block data X+1. In another embodiment, the block data generating unit 301 may read previous block data X from the second recording medium 33 and calculate a hash value thereof when block data X+1 is generated.

Next, the block data generating unit 301 distributes the newly-generated block data X+1 to the plurality of participant servers 2A and 2B (Step S106) and records the block data on the second recording medium 33 (Step S107).

When the block data X+1 generated by the central server 3 is received, the recording processing unit 202 of each of the participant servers 2A and 2B records the received block data on the first recording medium 23 (Step S108).

In addition, the first verification information transmitting unit 203 of each of the participant servers 2A and 2B transmits first verification information about block data recorded on its own first recording medium 23 to the other participant servers 2 and the central server 3 (Step S109). FIG. 5 illustrates an example in which the first verification information transmitting unit 203 of the participant server 2B transmits first verification information to the participant server 2A and the central server 3. Although not illustrated in the drawing, similarly, the first verification information transmitting unit 203 of the participant server 2A also transmits the first verification information to the participant server 2B and the central server 3.

Similarly, the second verification information transmitting unit 303 of the central server 3 transmits second verification information about block data recorded on the second recording medium 33 to each of the plurality of participant servers 2A and 2B (Step S110).

Next, in each server, the verification information acquiring unit 400 of the detection unit 40 acquires the first verification information from each of the plurality of participant servers 2A and 2B and acquires second verification information from the central server 3 (Step S112). FIG. 5 illustrates an example in which the verification information acquiring unit 400 of the participant server 2A acquires the first verification information from the other participant server 2B and acquires the second verification information from the central server 3. For example, the first verification information and the second verification information are block data recorded in the participant servers 2A and 2B and the central server 3, respectively.

The comparison unit 401 of the detection unit 40 compares the first verification information (block data of the participant servers 2A and 2B) with the second verification information (block data of the central server 3) and determines the presence or absence of tampering of block data recorded in the central server 3 (Step S113). FIG. 5 illustrates an example in which the comparison unit 401 of the participant server 2A compares the first verification information (block data of the participant server 2A) recorded on the first recording medium 23, the first verification information (the block data of the participant server 2B) acquired from the other participant server 2, and the second verification information (the block data of the central server 3) acquired from the central server 3 with each other and determines the presence or absence of tampering of block data recorded in the central server 3. In addition, although not illustrated, a similar process is performed in parallel also in the participant server 2B and the central server 3.

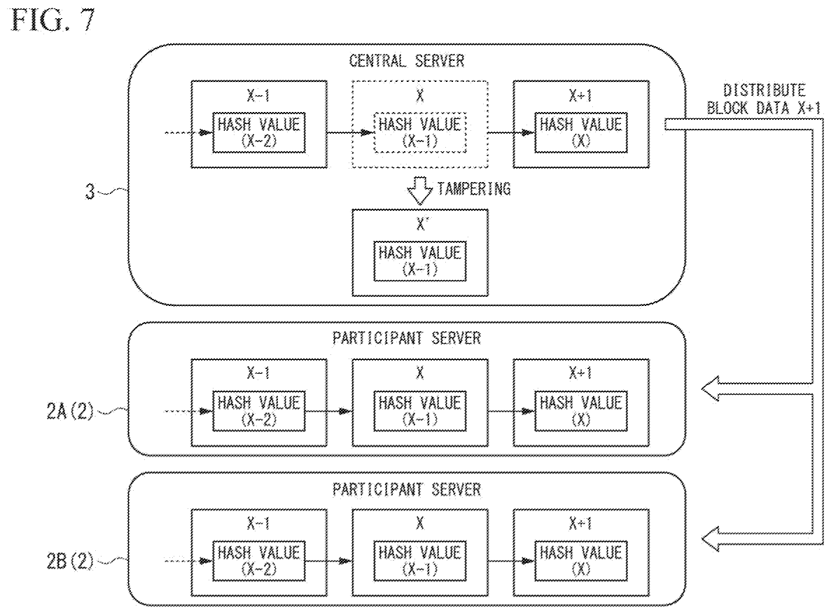

FIG. 7 is a diagram illustrating a function of the comparison unit according to the first embodiment.

For example, as illustrated in FIG. 7, after block data X is generated and distributed, before next block data X+1 is generated and distributed, the block data X of the central server 3 is assumed to have been tampered with block data X′. In addition, the block data X of each of the participant servers 2A and 2B is assumed not be have been tampered. In this case, in a system using a conventional block chain, when the block data X+1 is distributed, re-verification for the block data X including transaction data that has already been approved by each participant server is not performed. Thus, in the conventional system, there is a possibility of being unable to detect tampering of the block data X in this central server 3.

For this reason, in this embodiment, the comparison unit 401 of the detection unit 40 compares each piece of block data recorded in the central server 3 with each piece of block data recorded in the participant servers 2A and 2B.

In a case in which the block data (the second verification information) of the central server 3 does not coincide with block data (the first verification information) of participant servers 2 of a predetermined number or more (for example, ⅔ or more) (Step S113: No), the comparison unit 401 determines that the block data of the central server 3 has been tampered. Then, the notification unit 402 of the detection unit 40 notifies a verification result indicating that block data has been tampered to the participant servers 2A and 2B and the central server 3 (Step S115). FIG. 5 illustrates an example in which the notification unit 402 of the participant server 2A notifies a verification result to the other participant server 2B and the central server 3. Although not illustrated in the drawing, similar processes are performed in parallel also in the participant server 2B and the central server 3.

In this verification result, information indicating which block data that has been tampered may be included. For example, in the example illustrated in FIG. 7, the block data X′ of the central server 3 and the block data X of each of the participant servers 2A and 2B do not coincide with each other (Step S113: No), and thus the comparison unit 401 determines that the block data X′ of the central server 3 has been tampered. In this case, the notification unit 402 of the participant server 2A notifies the participant server 2B and the central server 3 of a verification result indicating that the block data X′ of the central server 3 has been tampered (Step S115). At this time, the block data generating unit 301 of the central server 3 may perform correction through replacement of the tampered block data with correct block data by referring to the block data recorded in the plurality of participant servers 2A and 2B. In addition, in a case in which block data recorded in the plurality of participant servers 2 do not coincide with each other, the block data generating unit 301 may determine that block data common to participant servers 2 of a predetermined number or more (for example, ⅔ or more) is correct block data.

On the other hand, in a case in which block data of the central server 3 coincides with block data of participant servers 2 of the predetermined number or more (Step S113: Yes), the comparison unit 401 determines that the block data of the central server 3 has not been tampered. At this time, the notification unit 402 notifies the client CL of normal completion of the requested transaction (Step S114). In addition, the notification unit 402 notifies the participant servers 2A and 2B and the central server 3 of a verification result indicating that the block data of the central server 3 has not been tampered (Step S115). FIG. 5 illustrates an example in which the notification unit 402 of the participant server 2A transmits a transaction completion notification to the client CL (Step S114) and notifies the other participant server 2B and the central server 3 of a verification result (Step S115). Although not illustrated in the drawing, similar processes are performed in parallel with each other also in the participant server 2B and the central server 3. In addition, in a case in which a transaction completion notification has been received from servers of a prescribed number (for example, a majority) or more, the client CL may determine that the transaction has been normally executed. In another embodiment, any one of the participant servers 2A and 2B and the central server 3 may representatively transmit a transaction completion notification to the client CL. In such a case, for example, in a case in which verification results indicating that tampering has not been made have been received from servers of a prescribed number or more, the notification unit 402 of the representative server transmits a transaction completion notification to the client CL.

### (Actions and Effects)

As described above, the detecting device according to this embodiment (the participant server 2 and the central server 3) includes the verification information acquiring unit 400 that acquires first verification information about block data recorded in the participant server 2 and second verification information about block data recorded in the central server 3 respectively from each of a plurality of participant servers 2 and the central server 3 configuring a block chain and a comparison unit 401 that compares the first verification information with the second verification information and determines the presence or absence of tampering of block data in the central server 3.

By configuring as such. the participant servers 2 and the central server 3 can detect the presence or absence of tampering, of block data in the central server 3 that generates block data of the block chain.

In addition, in a case in which the second verification information (block data) of the central server 3 does not coincide with the first verification information (block data) of participant servers 2 of a predetermined number or more, the comparison unit 401 determines that the block data of the central server 3 has been tampered.

In that case, in order to tamper block data without any contradiction, block data of the central server 3 and participant servers 2 of a predetermined number or more needs to be tampered. For this reason. the participant servers 2 and the central server 3 can further increase difficulty in tampering in the block chain.

In addition, the verification information acquiring unit acquires block data recorded in a plurality of participant servers 2 and the central server 3 as the first verification information and the second verification information, respectively.

By configuring as such. the participant servers 2 and the central server 3 collates block data recorded in the central server 3 with block data recorded in the participant server 2 one piece by one piece, and thereby is able to reliably detect tampering of the block data.

In addition, the participant server 2 according to this embodiment includes the transaction data verifying unit 201 that verifies whether transaction data accepted from the client CL is valid, the recording processing unit 202 that receives block data including the transaction data determined as being valid from the central server 3 and records the received block data in the first recording medium 23, and the first verification information transmitting unit 203 that transmits the first verification information about block data recorded in the first recording medium 23 to the other participant server 2 and the central server 3.

By configuring as such, the participant server 2 can provide the first verification information that can be used for detecting tampering of block data of the central server 3 for each server functioning as a detecting device.

In addition, the central server 3 according to this embodiment includes the block data generating unit 301 that generates block data including transaction data determined as being valid by a plurality of participant servers 2 and records the generated block data in the second recording medium 33, the block data transmitting unit 302 that transmits the generated block data to the plurality of participant servers 2, and the second verification information transmitting unit 303 that transmits the second verification information about block data recorded in the second recording medium 33 to the participant servers 2.

By configuring as such, the central server 3 can provide the second verification information that can be used for detecting tampering of block data of the central server 3 for the participant server 2 functioning as a detecting device.

In the above description, although an example in which the first verification information and the second verification information are block data recorded in each of the participant servers 2A and 2B and the central server 3 has been described, the configuration is not limited thereto. In another embodiment, the verification information acquiring unit 400 may acquire a CRC value of block data recorded in each of the plurality of participant servers 2A and 2B and the central server 3 as the first verification information and the second verification information.

By configuring as such, the comparison unit 401 can shorten a processing time more than in a case in which block data of the central server 3 and block data of each of the participant servers 2A and 2B are compared with each other. In addition, the verification information acquiring unit 400 acquires only a CRC value of each block data, and thus traffic between the participant severs 2A and 2B and the central server 3 can be reduced.

In addition, the verification information acquiring unit 400 may acquire the number of pieces of block data recorded in each of the plurality of participant servers 2A and 2B and the central server 3 as the first verification information and the second verification information.

Similar to the example illustrated in FIG. 7, after the block data X is generated and distributed and before the block data X+1 is generated and distributed, the block data X of the central serve 3 is assumed to be tampered with the block data X′. At this time, the block data X+1 distributed from the central serve 3 is recorded in the participant servers 2A and 2B with being connected to the block data X. In addition, as illustrated in FIG. 7, when a hash value of block data X before tampering is included in the block data X+1, the hash value of the block data X and a hash value included in the block data X+1 coincide with each other in the participant server 2, and thus such block data X and X+1 are stored with being normally connected to each other. On the other hand, in the central server 3, a hash value of block data X′ after tampering and the hash value included in the block data X+1 (the hash value of the block data X before tampering) do not coincide with each other, and thus there are cases in which the block data X+1 is not recorded in the central server 3. As a result, the number of pieces of block data recorded in the central server 3 and the number of pieces of block data recorded in each of the participant servers 2A and 2B do not coincide with each other. For this reason, by comparing the numbers of pieces of block data recorded in the participant servers 2A and 2B and the central server 3. the comparison unit 401 can detect tampering of the block data of the central server 3. In addition, the comparison unit 401 may perform a simple process of only comparing the numbers of pieces of block data with each other, and thus the processing time can be shortened.

### Modified Example of First Embodiment

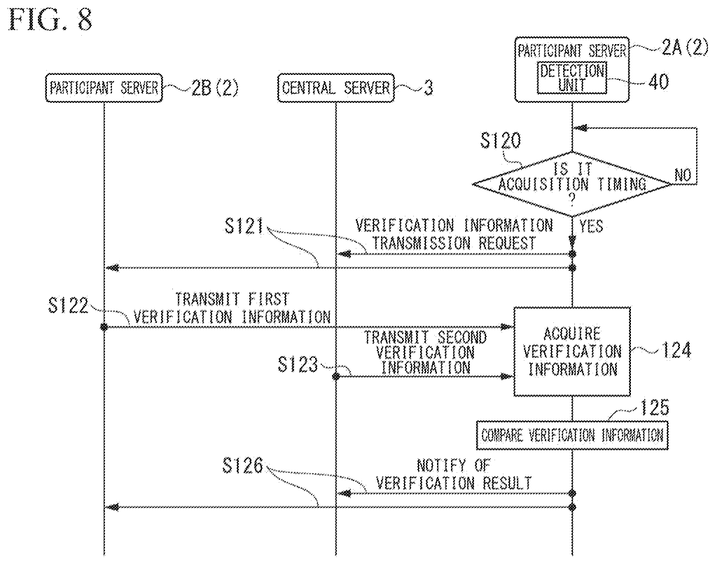

In the first embodiment described above, although an example in which, every time when new block data is generated and distributed, the first verification information transmitting unit 203 of the participant server 2 and the second verification information transmitting unit 303 of the central server 3 transmit the first verification information and the second verification information has been explained, the configuration is not limited thereto. For example, in this modified example, in each server, the verification information acquiring unit 400 of the detection unit 40 acquires the first verification information and the second verification information from the participant server 2 and the central server 3 at a timing at which a predetermined time (for example, 10 minutes) elapses. Hereinafter, a modified example of the first embodiment will be described with reference to FIG. 8.

FIG. 8 is a diagram illustrating an example of a process of a tamper detecting system according to a modified example of the first embodiment.

FIG. 8 illustrates an example in which the detection unit 40 of the participant server 2A performs a process of detecting tampering. As illustrated in FIG. 8, in the participant server 2A, the verification information acquiring unit 400 of the detection unit 40 determines whether or not it is a timing at which the first verification information and the second verification information are acquired (Step S120). In a case in which a predetermined time has not elapsed after the previous acquisition of the first verification information and the second verification information (Step S120: No), the verification information acquiring unit 400 waits until it becomes an acquisition timing. On the other hand, in a case in which a predetermined time has elapsed after the previous acquisition of the first verification information and the second verification information (Step S120: Yes), the verification information acquiring unit 400 requests the other participant server 2B and the central server 3 to transmit the verification information (Step S121).

In that case. the first verification information transmitting unit 203 of the participant server 2B transmits the first verification information to the participant server 2A (Step S122). Similarly. the second verification information transmitting unit 303 of the central server 3 transmits the second verification information to the participant server 2A (Step S123).

When the verification information acquiring unit 400 of the participant server 2A acquires the first verification information and the second verification information (Step S124), the comparison unit 401 determines the presence or absence of tampering of block data recorded in the central server 3 by comparing the first verification information with the second verification information (Step S125). This process is similar to the process according to the first embodiment (Step S113 illustrated in FIG. 5).

In addition, the notification unit 402 of the participant server 2A notifies the participant server 2B and the central server 3 of a verification result indicating whether or not block data of the central server 3 has been tampered (Step S126).

By configuring as such, the participant server 2A can regularly check the presence or absence of tampering of the block data of the central server 3 regardless of the presence or absence of a transaction execution request from the client CL. In FIG. 8, although an example in which the participant server 2A functions as a detecting device and detects the presence or absence of tampering of the block data has been illustrated, the configuration is not limited thereto. In another embodiment, the participant server 2B and/or the central server 3 may function as detecting devices and perform each of the steps described above instead of the participant server 2A or together with the participant server 2A. In addition, in another embodiment, the participant servers 2A and 2B and the central server 3 may take turns to perform the processes described above for each predetermined period.

### Second Embodiment

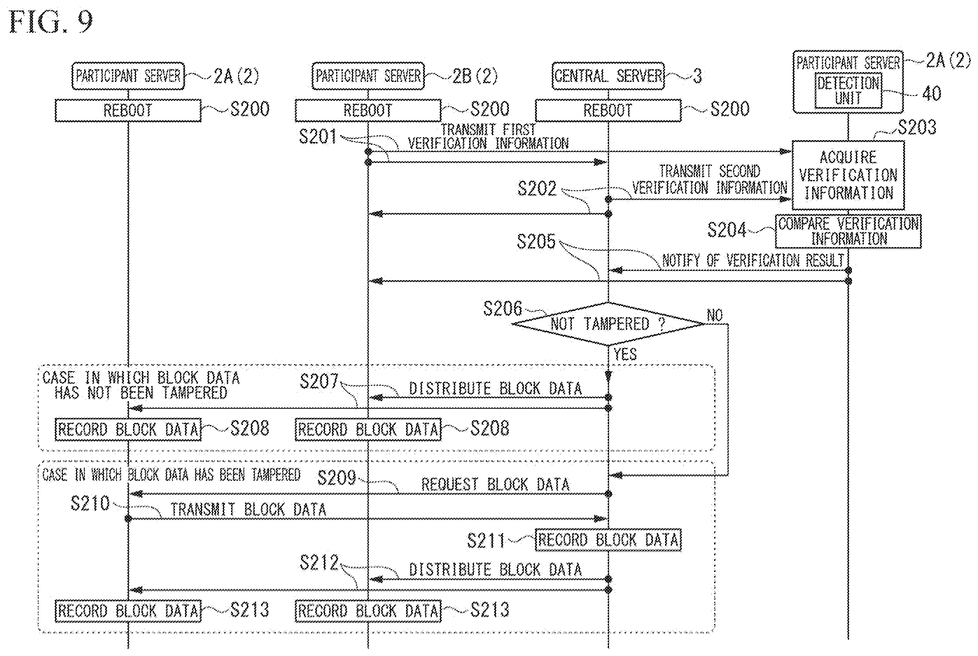

Next, a tamper detecting system 1 according to a second embodiment of the present invention will he described with reference to FIG. 9.

The same reference signs will be assigned to constituent elements common to the first embodiment, and detailed description thereof will be omitted.

For example, all the participant servers and a central server are assumed to reboot due to an attack or the like from the outside of the system. In a conventional system, in a case in which all the participant servers reboot, block data recorded in a central server is distributed to each participant server and is replicated. However, in a case in which block data of the central server has been tampered, consistency between hash values of tampered block data and pieces of block data before and after the tampered block data is not taken, and thus block data after the tampered block data is not recorded in the participant server. In that case, there is a possibility of block data after the tampered block data being lost from the participant server. For this reason, by performing processes illustrated in FIG. 9, the tamper detecting system 1 according to this embodiment prevents block data from disappearing after the reboot of the participant server 2.

### (Process Flow)

FIG. 9 is a diagram illustrating an example of a process of the tamper detecting system according to the second embodiment.

FIG. 9 illustrates an example in which a participant server 2A functions as a detecting device and performs a process of detecting the presence or absence of tampering. As illustrated in FIG. 9, participant servers 2A and 2B and a central server 3 are assumed to reboot due to an attack or the like from the outside of the system (Step S200). In that case, a first verification information transmitting unit 203 of each of the participant servers 2A and 2B transmits first verification information to the other participant server 2 and the central server 3 (Step S201). Similarly, a second verification information transmitting unit 303 of the central server 3 transmits second verification information to the participant servers 2A and 2B (Step S202).

In the participant server 2A, when a verification information acquiring unit 400 of a detection unit 40 acquires first verification information and second verification information (Step S203), a comparison unit 401 determines whether or not block data of the central server 3 has been tampered by comparing the first verification information with the second verification information (Step S204). This process is similar to the process according to the first embodiment (Step S113 illustrated in FIG. 5).

In addition, a notification unit 402 of the participant server 2A notifies the participant server 2B and the central server 3 of a verification result indicating whether or not block data of the central server 3 has been tampered (Step S205).

Next, a block data generating unit 301 and a block data transmitting unit 302 of the central server 3 determines whether or not tampering of block data has been detected by referring to the verification result notified from the detection unit 40 of the participant server 2A (Step S206).

In a case in which tampering of the block data has not been detected (Step S206: Yes), the block data transmitting unit 302 distributes block data recorded in a second recording medium 33 to all the participant servers 2A and 2B (Step S207).

In that case, a recording processing unit 202 of each of the participant servers 2A and 2B records the block data distributed from the central server 3 in the first recording medium 23 (Step S208). In accordance with this. even after a reboot is performed, block data of the same details can he included in the participant servers 2A and 2B and the central server 3. In accordance with this, the tamper detecting system 1 can inhibit block data after the tampered block data from being lost in the participant server 2.

On the other hand, in a case in which tampering of the block data has been detected (Step S206: No), the block data generating unit 301 of the central server 3 requests the participant server 2 to transmit the block data (Step S209). At this time, the block data generating unit 301 may determine block data common to participant servers 2 of a predetermined number or more (for example, ⅔ or more) as being correct block data and request the participant server 2 having this correct block data (in the example illustrated in FIG. 9. the participant server 2A) to transmit the block data. In addition, in a case in which information indicating block data that has been tampered is included in the verification result, the block data generating unit 301 may request the participant server 2A to transmit only the tampered block data and subsequent block data.

When a transmission request for transmitting block data is received from the central server 3, the recording processing unit 202 of the participant server 2A reads block data from the first recording medium 23 and transmits the read block data to the central server 3 (Step S210).

The block data generating unit 301 of the central server 3 records the block data received from the participant server 2A in the second recording medium 33 (Step S211).

In addition, when correct block data is restored using the block data received from the participant server 2A, the central server 3 distributes the restored block data to all the participant servers 2A and 2B (Step S212).

In that case, the recording processing unit 202 of each of the participant servers 2A and 2B records the block data distributed from the central server 3 in the first recording medium 23 (Step S213). As a result, even after the block data of the central server 3 is tampered. and a reboot is performed, correct block data can he restored and synchronized in the participant servers 2A and 2B and the central server 3. In this way, the tamper detecting system 1 can prevent block data connected after the tampered block data from being lost in the participant server 2. In addition, in FIG. 9, although an example in which the participant server 2A functions as a detecting device and detects the presence or absence of tampering of block data is illustrated, the configuration is not limited thereto. In another embodiment, the participant server 2B or the central server 3 may function as a detecting device and perform each of the steps described above instead of the participant server 2A. In addition, the participant servers 2A and 2B and the central server 3 may perform the steps described above in parallel with each other. In such a case, in a case in which verification results indicating that tampering has not been detected are obtained in servers of a prescribed number (for example, a half) or more, the block data generating unit 301 of the central server 3 may determine that the block data has not been tampered in Step S206 (Step S206: Yes).

### Third Embodiment

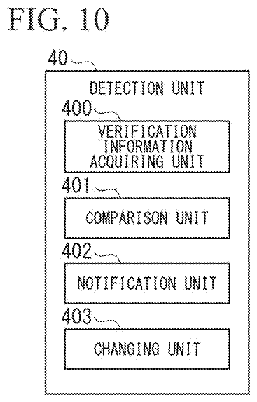

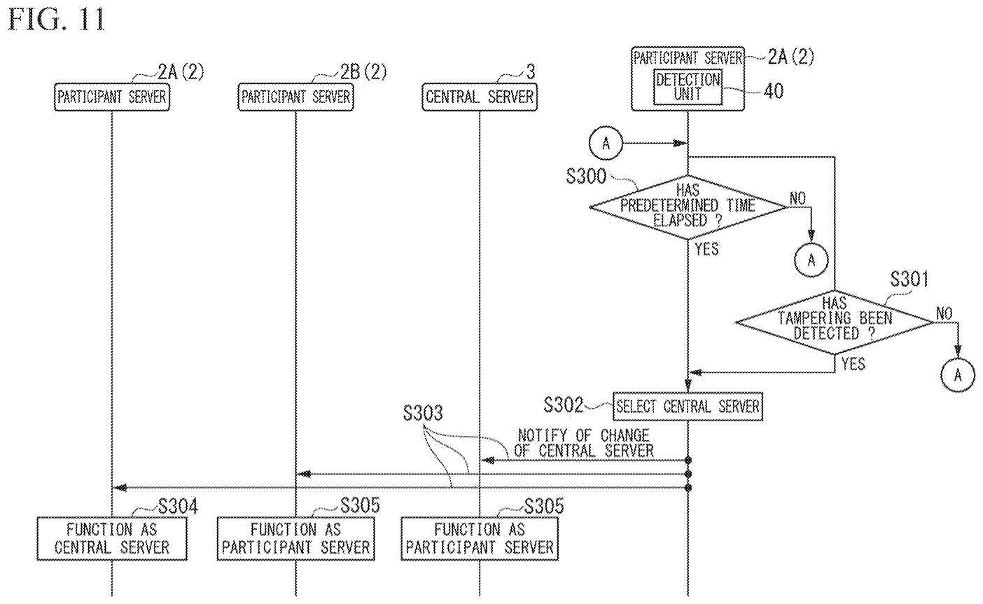

Next, a tamper detecting system 1 according to a third embodiment of the present invention will he described with reference to FIGS. 10 and 11.

The same reference signs will he assigned to constituent elements common to the first and second embodiments, and detailed description thereof will be omitted.

In a block chain, a central server 3 having a right for generating block data may tend to become a target for attack like data tampering. For this reason, the tamper detecting system 1 according to this embodiment further includes a functional configuration for reducing the possibility of the central server 3 being attacked.

FIG. 10 is a diagram illustrating a functional configuration of a detection unit of each of a participant server and a central server according to the third embodiment.

As illustrated in FIG. 10, the detection unit 40 according to this embodiment further has a function of a changing unit 403. The changing unit 403 changes one participant server 2 selected from among a plurality of participant servers 2 to a central server 3 at a predetermined timing. The predetermined timing is a timing at which a predetermined time has elapsed or a timing at which tampering of block data of the central server 3 has been detected.

### (Process Flow)

FIG. 11 is a diagram illustrating an example of a process of the tamper detecting system according to the third embodiment.

FIG. 11 illustrates an example in which the detection unit 40 of a participant server 2A performs a process of changing a central server. As illustrated in FIG. 11, in the participant server 2A, the changing unit 403 of the detection unit 40 determines whether or not a predetermined time (for example, 12 hours) has elapsed after the central server 3 was changed at the previous time (Step S300). In a case in which the predetermined time has not elapsed (Step S300: No), the changing unit 403 waits until the predetermined time elapses. On the other hand, in a case in which the predetermined time has elapsed (Step S300: Yes), the changing unit 403 selects a new central server 3 (Step S302).

The changing unit 403 determines whether or not tampering of the central server 3 has been detected on the basis of a verification result acquired by the comparison unit 401 in parallel with Step S300 (Step S3011. In a case in which no tampering has been detected (Step S301: No), the changing unit 403 waits until a next verification result is output from the comparison unit 401. On the other hand, in a case in which tampering has been detected (Step S301: Yes), the changing unit 403 selects a new central server 3 (Step S302).

In a case in which the predetermined time has elapsed (Step S300: Yes) or in a case in which tampering of the central server 3 has been detected (Step S301: Yes), the changing unit 403 selects a new central server 3 (Step S302). For example, the changing unit 403 selects a server which is most previously (or the recently) booted among a plurality of participant servers 2A and 2B as a central server 3. In addition, the changing unit 403 selects a server of which the processing speed is the highest among the plurality of participant servers 2A and 2B as a central server 3. In addition, the participant server 2 selected as the central server 3 once may be excluded from selection targets until all the other participant servers 2 are selected as the central server 3. By configuring as such, for example. occurrence of deviation in selected servers such as two participant servers 2, of which processing speeds are high, being continued to he selected alternately as the central server 3 can be prevented.

Next, the notification unit 402 notifies the participant servers 2A and 2B and the central server 3 of a change of the central server (Step S303). For example. the changing unit 403 is assumed to select the participant server 2A as a next central server 3. In that case, after receiving a notification from the detection unit 40, the participant server 2A functions as a central server. Similarly, after receiving a notification from the detection unit 40, the participant server 2B and the central server 3 function as participant servers.

In this way, the detection unit 40 changes one participant server 2 selected from among the plurality of participant servers 2 to a central server 3 at a predetermined timing. In accordance with this, it becomes more difficult to attack the central server 3 than in a case in which the central server 3 is fixed.

### Fourth Embodiment

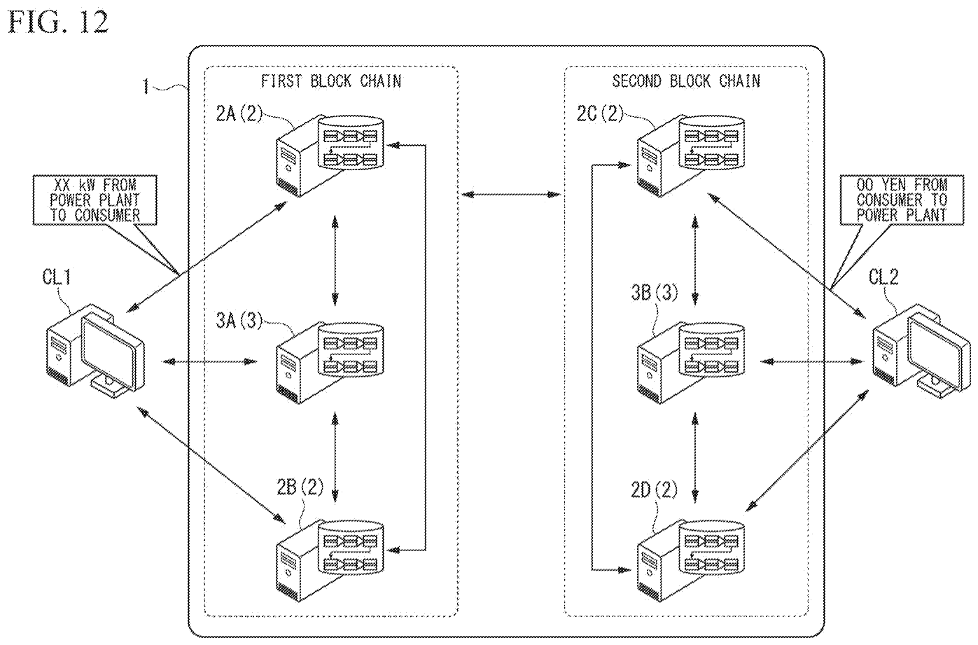

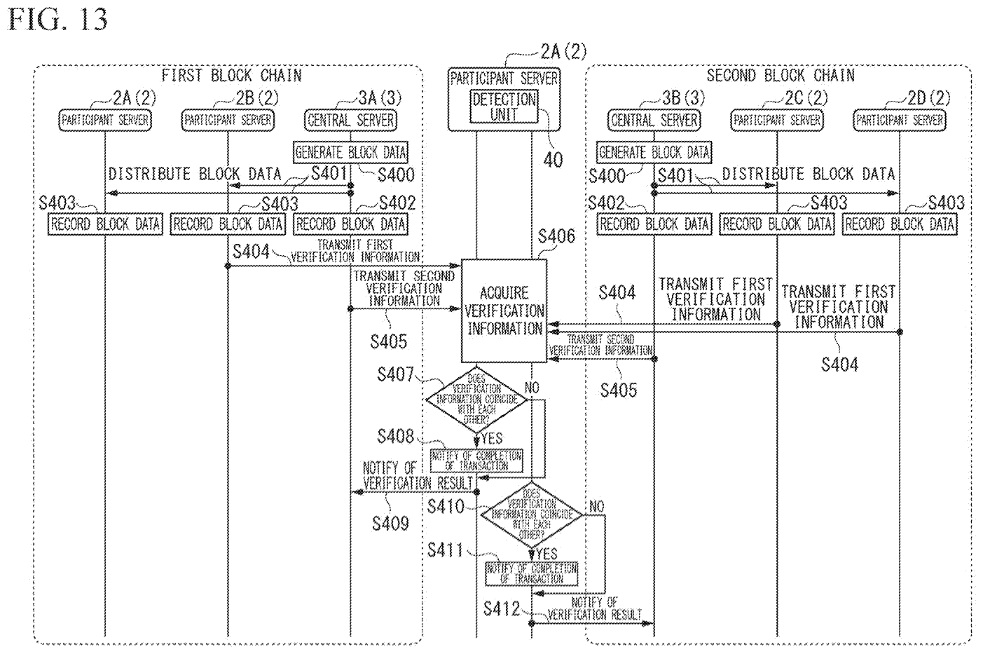

Next, a tamper detecting system 1 according to a fourth embodiment of the present invention will be described with reference to FIGS. 12 and 13.

The same reference signs will be assigned to constituent elements common to the first to third embodiments, and detailed description thereof will be omitted.

### (General Configuration)

FIG. 12 is a diagram illustrating a general configuration of a tamper detecting system according to a fourth embodiment.

As illustrated in FIG. 12, the tamper detecting system 1 according to this embodiment includes a first block chain and a second block chain. The first block chain is composed of a plurality of participant servers 2A and 2B and a central server 3A.

The second block chain is composed of a plurality of participant servers 2C and 2D and a central server 3B. The participant servers 2A, 2B, 2C, and 2D have the same functional configuration. In addition, the central servers 3A and 3B have the same functional configuration.

The detection unit 40 according to this embodiment detects tampering of block data recorded in the central server 3A of the first block chain and detects tampering of block data recorded in the central server 3B of the second block chain.

In the tamper detecting system 1 according to this embodiment, the first block chain and the second block chain manage information that can he mutually converted using functions set in advance. For example, in a case in which the tamper detecting system 1 manages information about power transactions, transaction data relating to transmission/reception of electric power (for example, electric power (kW) supplied from a power plant to a consumer) is assumed to be recorded in the first block chain, and transaction data relating to a transaction of money based on transmitted/received electric power (for example, an electricity charge (Japanese Yen) paid from a consumer to a power plant) is assumed to be recorded in the second block chain. The supplied electric power (kW) and the electricity charge (Yen) can be converted to and from each other using functions set in advance.

In this embodiment, a client CL1 transmits transaction data including information that can be used for identifying a supply source (a power company operating a power plant) and a supply destination (a consumer) of electric power and a supplied electric power (kW) to the participant servers 2A and 2B configuring the first block chain. When this transaction data is verified and approved by the participant servers 2A and 2B, the central server 3A generates block data including the transaction data and distributes the generated block data to the participant servers 2A and 2B. In this way, transaction data relating to transmission/reception of electric power is shared and managed within first block data.

In addition, a client CL2 transmits transaction data including information that can be used for identifying a remitter (a consumer) and a remittee (a power company) of an electricity charge and the electricity charge (Yen) to the participant servers 2C and 2D configuring the second block chain. When this transaction data is verified and approved by the participant servers 2C and 2D, the central server 3B generates block data including the transaction data and distributes the generated block data to the participant servers 2C and 2D. In this way, transaction data relating to transactions of electricity charges is shared and managed within second block data.

### (Process Flow)

FIG. 13 is a diagram illustrating an example of a process of the tamper detecting system according to the fourth embodiment.

Hereinafter, an example of the process of the tamper detecting system 1 according to this embodiment will be described in detail with reference to FIG. 13. Processes until a block data generation request is transmitted to the central servers 3A and 3B after the clients CL1 and CL2 transmit transaction execution requests to the participant servers 2A, 2B, 2C, and 2D are similar to the processes according to the first embodiment (Steps S100 to S104 illustrated in FIG. 5), and thus description thereof will be omitted. FIG. 13 illustrates an example in which the participant server 2A of the first block chain functions as a detecting device and detects tampering in each of the first block chain and the second block chain.

As illustrated in FIG. 13, when a request accepting unit 300 of the central server 3A in the first block chain accepts a generation request for generating block data from the client CL1 (Step S104 illustrated in FIG. 5), a block data generating unit 301 generates block data including transaction data received from the client CL1 (Step S400).

Next, the block data generating unit 301 of the central server 3A distributes the newly-generated block data to the participant servers 2A and 2B belonging to the same first block chain (Step S401) and records the newly-generated block data in the second recording medium 33 (Step S402).

When block data generated by the central server 3A is received, a recording processing unit 202 of each of the participant servers 2A and 2B records the received block data in the first recording medium 23 (Step S403).

In addition, a first verification information transmitting unit 203 of the participant server 2B transmits first verification information about block data recorded in its own first recording medium 23 to the participant server 2A (Step S404).

Similarly, a second verification information transmitting unit 303 of the central server 3A transmits second verification information about block data recorded in a second recording medium 33 to the participant server 2A (Step S405).

In addition, similarly, the participant servers 2C and 2D and the central server 3B of the second block chain perform Steps S400 to S405.

Next, in the participant server 2A, a verification information acquiring unit 400 of a detection unit 40 acquires block data (first verification information) from each of the participant servers 2B, 2C, and 2D and acquires block data (second verification information) from each of the central servers 3A and 3B (Step S406). In this embodiment, the first verification information and the second verification information are block data recorded in each of the participant servers 2A, 2B, 2C, and 2D and each of the central servers 3A and 3B.

A comparison unit 401 of the detection unit 40 determines the presence or absence of tampering of block data recorded in the central server 3A of the first block chain on the basis of the second verification information (block data) acquired from the central server 3A of the first block chain and the first verification information (block data) acquired from the participant servers 2C and 2D of the second block chain (Step S407). As described above, transaction data relating to a supplied electric power (kW) is included in the block data of the central server 3A of the first block chain, and transaction data relating to an electricity charge (Yen) corresponding to this supplied electric power (kW) is included in the block data of each of the participant servers 2C and 2D of the second block chain. At this time, the comparison unit 401 acquires an electricity charge (Yen) corresponding to the supplied electric power (kW) included in the block data of the central server 3A using a prescribed function. In addition, the comparison unit 401 may acquire a supplied electric power (kW) corresponding to the electricity charge (Yen) included in the block data of each of the participant servers 2C and 2D using a prescribed function. By comparing data converted in this way, the comparison unit 401 determines the presence or absence of tampering by checking whether there is consistency between block data recorded in the central server 3A of the first block chain and block data recorded in each of the participant servers 2C and 2D of the second block chain.

In a case in which the block data of the central server 3A does not coincide with the block data of participant servers 2 of a predetermined number or more (for example, ⅔ or more) of the second block chain (Step S407: No), the comparison unit 401 determines that the block data of the central server 3A has been tampered. In that case, the notification unit 402 notifies the central server 3A of the first block chain of a verification result indicating that the block data has been tampered (Step S409). In this verification result, information indicating which block data of the central server 3A has been tampered may be included. In addition, the notification unit 402 may he configured to notify each of the participant servers 2A and 2B of the first block chain, the participant servers 2C and 2D of the second block chain, and the central server 3B of the second block chain of the same verification result.

On the other hand, in a case in which the block data of the central server 3A coincides with the block data of participant servers 2 of a predetermined number or more of the second block chain (Step S407: Yes), the comparison unit 401 determines that the block data of the central server 3A has not been tampered. At this time. the notification unit 402 notifies the client CL1 of normal completion of the requested transaction (Step S408). In addition, the notification unit 402 notifies the central server 3A of the first block chain of a verification result indicating that the block data has not been tampered (Step S409). In addition, the notification unit 402 may be configured to notify each of the participant servers 2A and 2B of the first block chain, the participant servers 2C and 2D of the second block chain, and the central server 3B of the second block chain of the same verification result.

Similarly, the comparison unit 401 determines the presence or absence of tampering of block data recorded in the central server 3B of the second block chain on the basis of the second verification information (block data) acquired from the central server 3B of the second block chain and the first verification information (block data) acquired from the participant servers 2A and 2B of the first block chain (Step S410). In addition, in the example illustrated in FIG. 13, the comparison unit 401 of the participant server 2A determines the presence or absence of tampering on the basis of the first verification information recorded in the first recording medium 23 of the participant server 2A, the first verification information acquired from the participant server 2B, and the second verification information acquired from the central server 3B of the second block chain.

In a case in which the block data of the central server 3B does not coincide with the block data of participant servers 2 of a predetermined number or more (for example, ⅔ or more) of the first block chain (Step S410: No), the comparison unit 401 determines that the block data of the central server 3B has been tampered. In that case, the notification unit 402 notifies the central server 3B of the second block chain a verification result indicating that the block data has been tampered (Step S412). In this verification result. information indicating which block data of the central server 3B has been tampered may be included. In addition, the notification unit 402 may be configured to notify each of the participant servers 2A and 2B of the first block chain, the participant servers 2C and 2D of the second block chain, and the central server 3A of the first block chain of the same verification result.

On the other hand, in a case in which the block data of the central server 3B coincides with the block data of participant servers 2 of a predetermined number or more of the first block chain (Step S410: Yes), the comparison unit 401 determines that the block data of the central server 3B has not been tampered. At this time, the notification unit 402 notifies the client CL2 of normal completion of the requested transaction (Step S411). In addition, the notification unit 402 notifies the central server 3B of the second block chain of a verification result indicating that the block data has not been tampered (Step S412). In addition, the notification unit 402 may be configured to notify each of the participant servers 2A and 2B of the first block chain. the participant servers 2C and 2D of the second block chain, and the central server 3A of the first block chain of the same verification result.

In addition, in FIG. 13, although an example in which the participant server 2A functions as a detecting device and detects the presence or absence of tampering of block data of each of the first block chain and the second block chain has been illustrated, the configuration is not limited thereto. In another embodiment, one of the participant servers 2B to 2D and the central servers 3A to 2B may function as a detecting device anti perform each of the steps described above instead of the participant server 2A.

In yet another embodiment, one server of the participant servers 2A to 2D and the central servers 3A and 3B may detect the presence or absence of tampering of the block data of the first block chain, and another server may detect the presence or absence of tampering of the block data of the second block chain. For example, in a case in which the participant server 2A functions as a detecting device of the first block chain, the participant server 2A detects the presence or absence of tampering of the block data of the first block chain (the central server 3A) on the basis of the second verification information of the central server 3A of the first block chain and the first verification information of each of the participant servers 2C and 2D of the second block chain. In a ease in which the participant server 2C functions as a detecting device of the second block chain, the participant server 2C detects the presence or absence of tampering of the block data of the second block chain (the central server 3B) on the basis of the second verification information of the central server 3B of the second block chain and the first verification information of each of the participant servers 2A and 2B of the first block chain.

By configuring as such, the participant server 2 and the central server 3 can detect tampering of both the central server 3A of the first block chain and the central server 3B of the second block chain.

In addition, in the tamper detecting system 1 according to this embodiment. in a case in which the block data of the central servers 3A and 3B is to be tampered. block data of the participant servers 2A, 2B, 2C, and 2D of both the first block chain and the second block chain and the conversion functions need to be tampered. Thus, the tamper detecting system 1, the participant server 2, and the central server 3 can further increase the difficulty in tampering of block data.

In addition, similar to the modified example of the first embodiment, the detection unit 40 according to this embodiment may be configured to detect tampering of the central server 3A of the first block chain and tampering of the central server 3B of the second block chain at a timing at which a predetermined time (for example, 10 minutes) has elapsed.

### <Hardware Configuration>

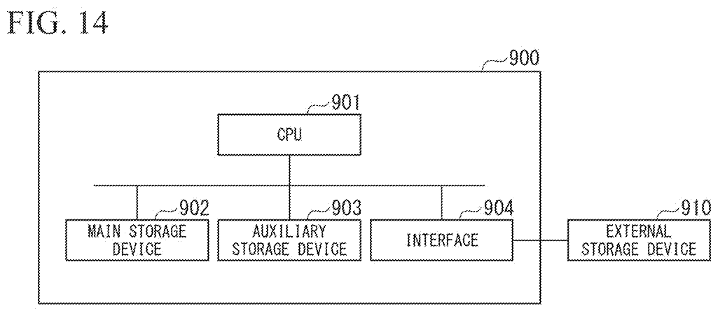

FIG. 14 is a diagram illustrating an example of a hardware configuration of the participant server and the central server according to at least one embodiment.

Hereinafter, an example of the hardware configuration of the participant server 2 and the central server 3 according to at least one of the embodiments described above will be described with reference to FIG. 14.

As illustrated in FIG. 14, a computer 900 includes a CPU 901, a main storage device 902. an auxiliary storage device 903, and an interface 904.

Each of the participant servers 2 and the central server 3 described above are mounted in the computer 900. The operation of each processing unit described above is stored in the auxiliary storage device 903 in the form of a program. The CPU 901 (the processor 20 or 30) reads a program from the auxiliary storage device 903, expands the read program into the main storage device 902 (the memory 21 or 31), and executes the process described above in accordance with the program. In addition, the CPU 901 secures a storage area used by the participant server 2 and the central server 3 for various processes in accordance with the program in the main storage device 902. In addition, the CPU 901 secures a storage area (the recording medium 23 or 33) storing data in the middle of processing in accordance with the program in the auxiliary storage device 903.

Examples of the auxiliary storage device 903 include a hard disk drive (HDD), a solid state drive (SSD), a magnetic disk, a magneto-optical disk, a compact disc read only memory (CD-ROM), a digital versatile disc react only memory (DVD-ROM), a semiconductor memory, and the like. The auxiliary storage device 903 may be an internal medium directly connected to a bus of the computer 900 or an external medium connected to the computer 900 through the interface 904 or a communication line. In addition, in a case in which this program is distributed to the computer 900 through a communication line, the computer 900 that has received the program may expand the program into the main storage device 902 and execute the process described above. In at least one embodiment, the auxiliary storage device 903 is a non-transitory tangible storage medium.

In addition, the program may be used for realizing some of the functions described above. Furthermore, the program may be a so-called a differential file (differential program) that realizes the functions described above in combination with another program stored in the auxiliary storage device 903 in advance.

As above, while several embodiments of the present invention have been described. all these embodiments are presented as examples and are not intended to limit the scope of the invention. These embodiments can he performed in other various forms, and various omissions, substitutions, and modifications can be made without departing from the spirit or scope of the invention. Accordingly, these embodiments and the modifications thereof, similar to a case of being included in the scope or the concept of the invention, are included in the invention described in the claims and the scope of equivalency thereof.

For example, in each of the embodiments described above. although an example in which at least one of the participant server 2 and the central server 3 detects the presence or absence of tampering of block data as a detecting device has been described, the configuration is not limited thereto. In another embodiment. the tamper detecting system I may further include another server that is different from the participant server 2 and the central server 3, and this server may have a function of a detecting device (the function of the detection unit 40).

### INDUSTRIAL APPLICABILITY

According to a detecting device, a central server, a tamper detecting system, a tamper detecting method, and a program relating to the present invention, tampering of block data in a central server that generates block data of a block chain can be detected.

### REFERENCE SIGNS LIST

1 Tamper detecting system

2, 2A, 2B, 2C, 2D Participant server (detection device)

20 Processor

200 Transaction data accepting unit

201 Transaction data verifying unit

202 Recording processing unit

203 First verification information transmitting unit

21 Memory

22 Interface

23 First recording medium

3, 3A, 3B Central server (detection device)

30 Processor

300 Request accepting unit

301 Block data generating unit

302 Block data transmitting unit

303 Second verification information transmitting unit

31 Memory

32 Interface

33 Second recording medium

40 Detection unit

400 Verification information acquiring unit

401 Comparison unit

402 Notification unit

403 Changing unit

CL, CL2, CL3 Client

1. A detecting device comprising:
a verification information acquiring unit configured to acquire second verification information about block data recorded in a central server that generates and distributes block data configuring a block chain and first verification information about block data recorded in a plurality of participant servers that record the distributed block data in a ledger of each of the plurality of participant servers; and
a comparison unit configured to determine the presence or absence of tampering of the block data in the central server by comparing the first verification information with the second verification information.

2. The detecting device according to claim 1, wherein the verification information acquiring unit acquires the block data recorded in each of the plurality of participant servers and the central server as the first verification information and the second verification information, respectively.

3. The detecting device according to claim 1, wherein the verification information acquiring unit acquires a CRC value of the block data recorded in each of the plurality of participant servers and the central server as the first verification information and the second verification information, respectively.

4. The detecting device according to claim 1, wherein the verification information acquiring unit acquires the number of pieces of the block data recorded in the plurality of participant servers and the central server as the first verification information and the second verification information, respectively.

5. The detecting device according to claim 1,
wherein the block chain includes a first block chain and a second block chain,
wherein the verification information acquiring unit acquires the first verification information from each of the plurality of participant servers of the first block chain and each of the plurality of participant servers of the second block chain and acquires the second verification information from the central server of the first block chain and the central server of the second block chain, and
wherein the comparison unit determines the presence or absence of tampering of the block data in the central server of the first block chain and the second block chain by comparing the second verification information acquired from the central server of the first block chain with the first verification information acquired from each of the plurality of participant servers of the second block chain and comparing the second verification information acquired from the central server of the second block chain with the first verification information acquired from each of the plurality of participant servers of the first block chain.

6. The detecting device according claim 1, further comprising a changing unit configured to change one participant server selected from among the plurality of participant servers to the central server.

7-10. (canceled)

11. A central server comprising:
a block data generating unit configured to generate block data including transaction data determined as being valid by a plurality of participant servers and record the generated block data in a second recording medium;
a block data transmitting unit configured to transmit the generated block data to the plurality of participant servers; and
a second verification information transmitting unit configured to transmit second verification information about the block data recorded in the second recording medium to a detecting device having a function of determining the presence or absence of tampering of the block data recorded in the second recording medium.

12. The central server according to claim 11, wherein the second verification information transmitting unit transmits the second verification information to the detecting device at one timing among a timing at which the block data is generated, a timing at which the second verification information is requested from the detecting device, or a timing at which the participant server reboots.

13. A central server comprising:
a block data generating unit configured to generate block data including transaction data determined as being valid by a plurality of participant servers and record the generated block data in a second recording medium;
a block data transmitting unit configured to transmit the generated block data to the plurality of participant servers; and
a second verification information transmitting unit configured to transmit second verification information about the block data generated before the block data to be transmitted and recorded in the second recording medium to a detecting device having a function of determining the presence or absence of tampering of the block data recorded in the second recording medium at a timing at which the generated block data is transmitted to the plurality of participant servers by the block data transmitting unit.

14. A participant server comprising:
a transaction data verifying unit configured to verify whether transaction data accepted from a client is valid;
a recording processing unit configured to receive block data including the transaction data determined as being valid from a central server and record the received block data in a first recording medium; and
a first verification information transmitting unit configured to transmit first verification information about the block data recorded in the first recording medium to a detecting device having a function of determining the presence or absence of tampering of the block data recorded in a central server that generates and distributes the block data configuring a block chain.

15. The participant server according to claim 14, wherein the first verification information transmitting unit transmits the first verification information to the detecting device at one timing among a timing at which the block data is received from the central server, a timing at which the first verification information is requested from the detecting device, or a timing at which the participant server reboots.

16-19. (canceled)
